(19) United States
(12) Patent Application Publication
(10) Pub. No.: US 2008/0072655 A1
(43) Pub. Date: Mar. 27, 2008

(54) Sudden Acceleration Support Coupling

(75) Inventors: Carl Williams, Austin, TX (US); Edwin Coleman Tinsley, Austin, TX (US)

Correspondence Address: HAYNES AND BOONE, LLP, 901 Main Street, Suite 3100, Dallas, TX, 75202, US

(73) Assignee: Dell Products L.P., Round Rock, TX (US)

(21) Appl. No.: 11/534,263

(22) Filed: Sep. 22, 2006

(51) Int. Cl. G01N 3/00

(52) U.S. Cl. 73/12.04

(57) ABSTRACT

A sudden acceleration testing apparatus includes a base. A support surface is moveably coupled to the base, wherein the support surface is operable to move relative to the base in order to create a sudden acceleration event. At least one vacuum device is located on the support surface and operable to couple a sudden acceleration test specimen to the support surface. A sudden acceleration test specimen such as, for example, an information handling system, may be coupled to the support surface for sudden acceleration testing by providing a vacuum between the sudden acceleration test specimen and the vacuum device.

### BACKGROUND

The present disclosure relates generally to information handling systems, and more particularly to a sudden acceleration support coupling for an information handling system testing apparatus.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs may be put through testing such as, for example, Highly Accelerated Life Test (HALT) testing or Highly Accelerated Stress Screen (HASS) testing, in order to ensure that the IHS is robust enough to survive the conditions that the IHS may experience in its lifetime such as, for example, during shipping of the IHS. The testing apparatus used to test the IHS can raise a number of issues.

Typically, the testing apparatus includes a sudden acceleration support surface that is operable to move in order to simulate shocks and vibrations that the IHS may experience during its lifetime. Conventionally, in order to transmit the sudden acceleration from the sudden acceleration support surface to the IHS, mounting devices that include compression members are mounted to the sudden acceleration support surface. The IHS is then coupled to the sudden acceleration support surface by applying a compressive force to the IHS with the compression members. Such compressive forces can introduce failures in the IHS that are not due strictly to the conditions introduced by the testing apparatus.

Accordingly, it would be desirable to provide a sudden acceleration support coupling absent the disadvantages found in the prior methods discussed above.

### SUMMARY

According to one embodiment, a sudden acceleration testing apparatus includes a base, a support surface moveably coupled to the base, wherein the support surface is operable to move relative to the base in order to create a sudden acceleration event, and at least one vacuum device located on the support surface and operable to couple a sudden acceleration test specimen to the support surface.

### BRIEF DESCRIPTION OF THE DRAWINGS

FIG. 1 is a schematic view illustrating an embodiment of an IHS.

FIG. 2 is a perspective view illustrating an embodiment of a sudden acceleration testing apparatus.

FIG. 3 is a perspective view illustrating an embodiment of a vacuum device used with the sudden acceleration testing apparatus of FIG. 2.

FIG. 4 is a perspective view illustrating an embodiment of a vacuum device coupling member used with the sudden acceleration testing apparatus of FIG. 2 and the vacuum device of FIG. 3.

FIG. 5 is a perspective view illustrating an embodiment of a vacuum device coupling member used with the sudden acceleration testing apparatus of FIG. 2 and the vacuum device of FIG. 3.

FIG. 6 is a perspective view illustrating an embodiment of a board support device used with the sudden acceleration testing apparatus of FIG. 2 and the vacuum device coupling member of FIG. 5.

FIG. 7a is a flow chart illustrating an embodiment of a method for sudden acceleration testing a test specimen.

FIG. 7b is a top view illustrating an embodiment of the vacuum device support member of FIG. 4 and the vacuum device of FIG. 3 coupled to the sudden acceleration testing apparatus of FIG. 2.

FIG. 7c is a perspective view illustrating an embodiment of a plurality of the vacuum device support members of FIG. 4 and a plurality of the vacuum devices of FIG. 3 coupled to the sudden acceleration testing apparatus of FIG. 2.

FIG. 7d is a perspective view illustrating an embodiment of a test specimen coupled to sudden acceleration testing apparatus of FIG. 7c.

FIG. 7e is a perspective view illustrating an embodiment of a plurality of the vacuum device support members of FIG. 5 and a plurality of the board support members of FIG. 6 coupled to the sudden acceleration testing apparatus of FIG. 2.

FIG. 7f is a perspective view illustrating an embodiment of a board test specimen coupled to the sudden acceleration testing apparatus of FIG. 7e.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

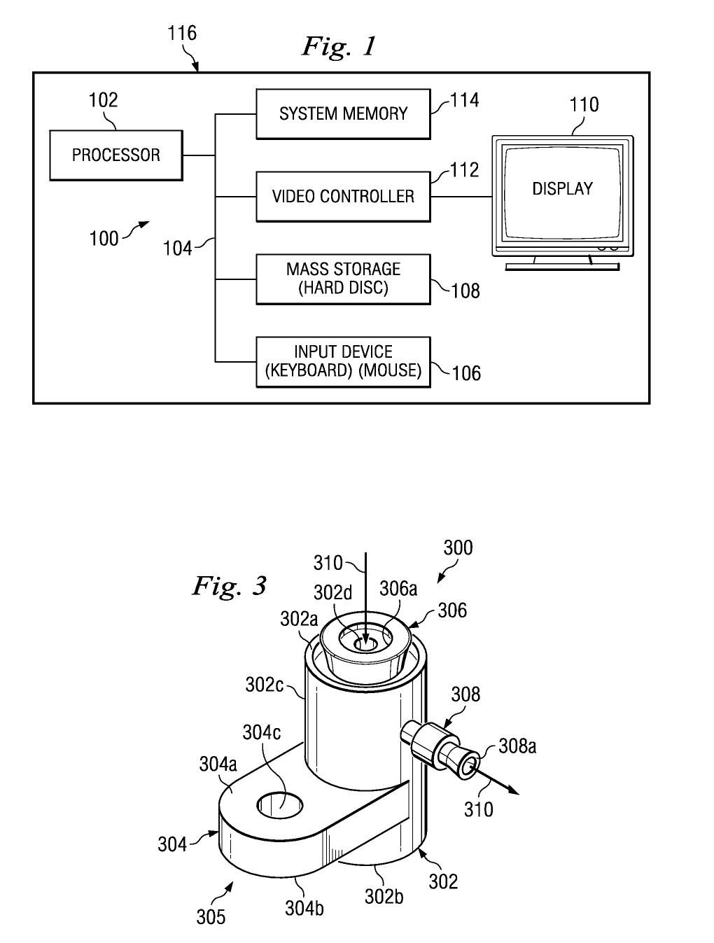

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

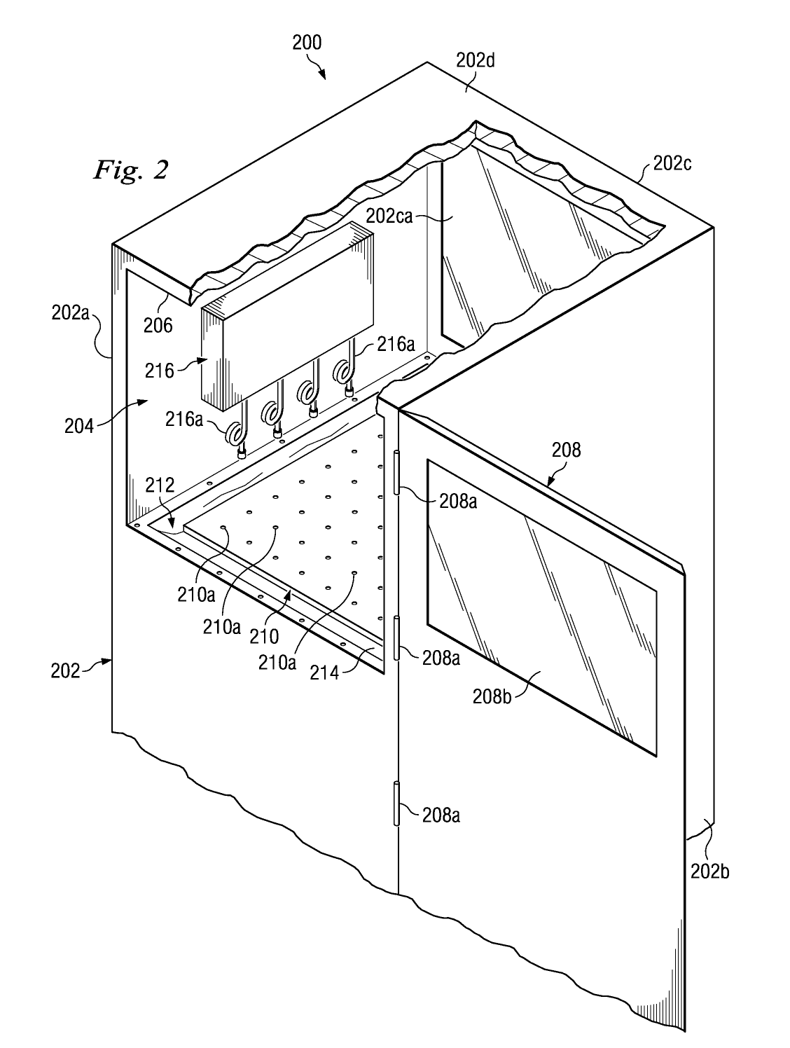

Referring now to FIG. 2, a sudden acceleration testing apparatus 200 is illustrated. The sudden acceleration testing apparatus 200 includes a base 202. A pair of opposing side walls 202a and 202b extend from the base 202 in a spaced apart and substantially parallel relationship to each other. A rear wall 202c extends from the base 202 and between the side walls 202a and 202b and includes a window 202ca substantially centrally located on the rear wall 202c. A top wall 202d extends between the side walls 202a and 202b and the rear wall 202c. A testing chamber 204 is defined between the base 202, the side walls 202a and 202b, the rear wall 202c, and the top wall 202d, and a chamber entrance 206 is defined by the base 202, the side walls 202a and 202b, and the rear wall 202c and is located immediately adjacent the testing chamber 204. A door 208 is pivotally coupled to the base 202 and the side wall 202b by a plurality of pivotal couplings 208a and includes a window 208b located on the door 208. A support surface 210 is located in the testing chamber 204 and moveably coupled to the base 202 using methods known in the art to allow the support surface 210 to move relative to the base 202 in order create a sudden acceleration event such as, for example, a shock event, a vibration event, and/or a variety of other sudden acceleration events known in the art. The support surface 210 defines a plurality of aperture mounting features 210a that are located on the support surface 210 in a spaced apart orientation from each other. A channel 212 is defined between the support surface 210 and the base 202 such that the support surface 202 may be allowed to move freely relative to the base 202, and a flexible material 214 extends between the support surface 210 and the base 202 to catch objects that may, for example, fall off of the support surface 210 and land between the support surface 210 and the base 202. A pump 216 is coupled to the side wall 202a and a plurality of hoses 216a extend from the pump 216. In an embodiment, the door 208 is operable to engage the base 202, the side walls 202a and 202b, and the top wall 202d in order to provide an gastight seal for the testing chamber 204. In an embodiment, the base 202 includes a temperature regulation device (not shown) which may include, for example, a nitrogen introduction system that allows the testing chamber to be filled with nitrogen in order to allow the testing chamber 204 to be rapidly cooled.

Referring now to FIG. 3, a vacuum device 300 is illustrated. The vacuum device 300 includes a base 302 having a top surface 302a, a bottom surface 302b located opposite the top surface 302a, and a side surface 302c extending between the top surface 302a and the bottom surface 302b. An air entrance 302d is defined by the base 302 and located on the top surface 302a of the base 302. A coupling arm 304 extends from the side surface 302c of the base 302, includes a top surface 304a and a bottom surface 304b located opposite the top surface 304a, and is spaced apart from the bottom surface 302b of the base 302 such that a coupling member channel 305 is defined adjacent the bottom surface 304b of coupling arm 304 and between the coupling arm 304 and the side surface 302c of the base 302. An aperture 304c is defined by the coupling arm 304, located adjacent a distal end of the coupling arm 304, and extends through the coupling arm 304 from the top surface 304a to the bottom surface 304b. A surface engagement member 306 extends from the top surface 302a of the base 302 adjacent the air entrance 302d on the top surface 302a of the base 302 and defines an air passageway 306a that is centrally located on the surface engagement member 306 and immediately adjacent the air entrance 302d on the top surface 302a of the base 302. A hose coupling 308 extends from the side surface 302c of the base 302 and defines an air exit 308a on its distal end. An air passageway 310 extends through the base 302 from the air entrance 302d on the top surface 302a of the base 302 to the air exit 308a on the distal end of the hose coupling 308.

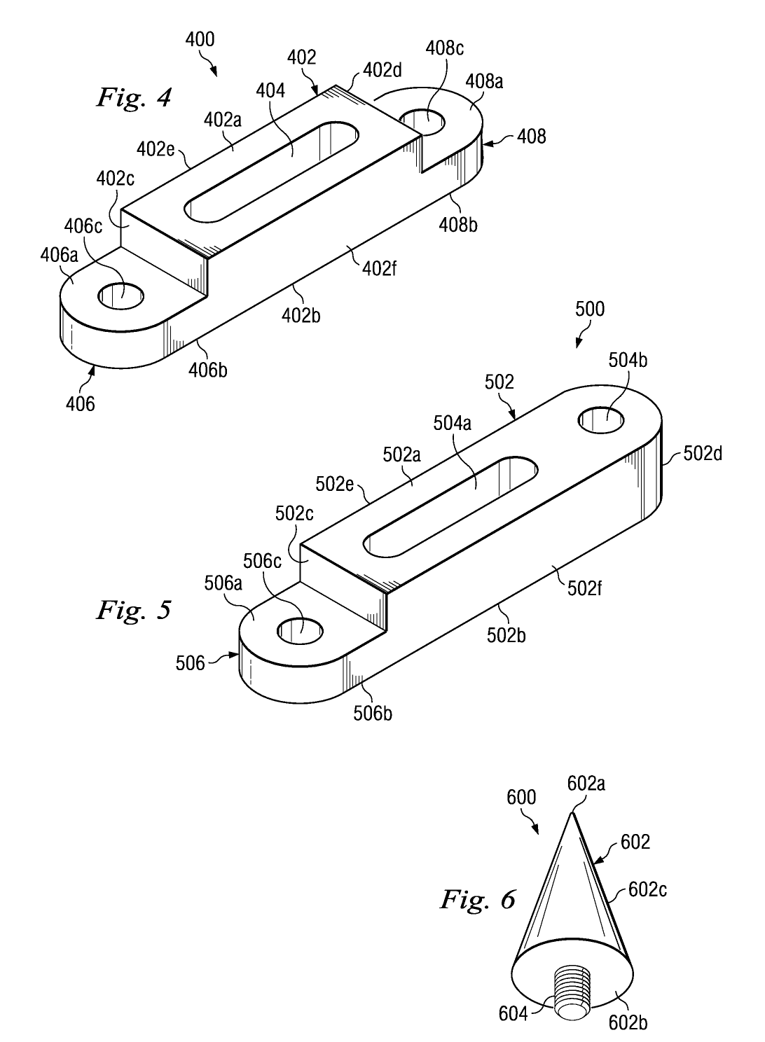

Referring now to FIG. 4, a vacuum device coupling member 400 is illustrated. The vacuum device coupling member 400 includes a base 402 having a top surface 402a, a bottom surface 402b located opposite the top surface 402a, a pair of opposing end surfaces 402c and 402d extending between the top surface 402a and the bottom surface 402b, and a pair of opposing side surfaces 402e and 402f extending between the top surface 402a, the bottom surface 402b, and the end surfaces 402c and 402d. An elongated support surface coupling passageway 404 is defined by the base 402, located along the length of the base 402, and extends through the base 402 from the top surface 402a to the bottom surface 402b. A coupling arm 406 extends from the side surface 402c of the base 402 and includes a top surface 406a that is spaced apart from the top surface 402a of the base 402 and a bottom surface 406b located opposite the top surface 406a. A vacuum device coupling aperture 406c is defined by the coupling arm 406, located adjacent a distal end of the coupling arm 406, and extends through the coupling arm 406 from the top surface 406a to the bottom surface 406b. A coupling arm 408 extends from the side surface 402d of the base 402 and includes a top surface 408a and a bottom surface 408b located opposite the top surface 408a. A vacuum device coupling aperture 408c is defined by the coupling arm 408, located adjacent a distal end of the coupling arm 408, and extends through the coupling arm 408 from the top surface 408a to the bottom surface 408b.

Referring now to FIG. 5, a vacuum device coupling member 500 is illustrated. The vacuum device coupling member 500 includes a base 502 having a top surface 502a, a bottom surface 502b located opposite the top surface 502a, a pair of opposing end surfaces 502c and 502d extending between the top surface 502a and the bottom surface 502b, and a pair of opposing side surfaces 502e and 502f extending between the top surface 502a, the bottom surface 502b, and the end surfaces 502c and 502d. An elongated support surface coupling passageway 504a is defined by the base 502, located along the length of the base 502, and extends through the base 502 from the top surface 502a to the bottom surface 502b. A board support device coupling aperture 504b is defined by the base 504, located between the elongated support surface coupling passageway 504a and the end surface 502d, and extends through the base 502 from the top surface 502a to the bottom surface 502b. A coupling arm 506 extends from the side surface 502c of the base 502 and includes a top surface 506a that is spaced apart from the top surface 502a of the base 502 and a bottom surface 506b located opposite the top surface 506a. A vacuum device coupling aperture 506c is defined by the coupling arm 506, located adjacent a distal end of the coupling arm 506, and extends through the coupling arm 506 from the top surface 506a to the bottom surface 506b.

Referring now to FIG. 6, a board support device 600 is illustrated. The board support device 600 includes a conical base 602 having a top surface 602a, a bottom surface 602b located opposite the top surface 602a, and a side surface 602c that extends between the top surface 602a and the bottom surface 602b. A coupling member 604 extends from the bottom surface 602b of the base 602 and, in an embodiment, includes a threaded member (as illustrated.)

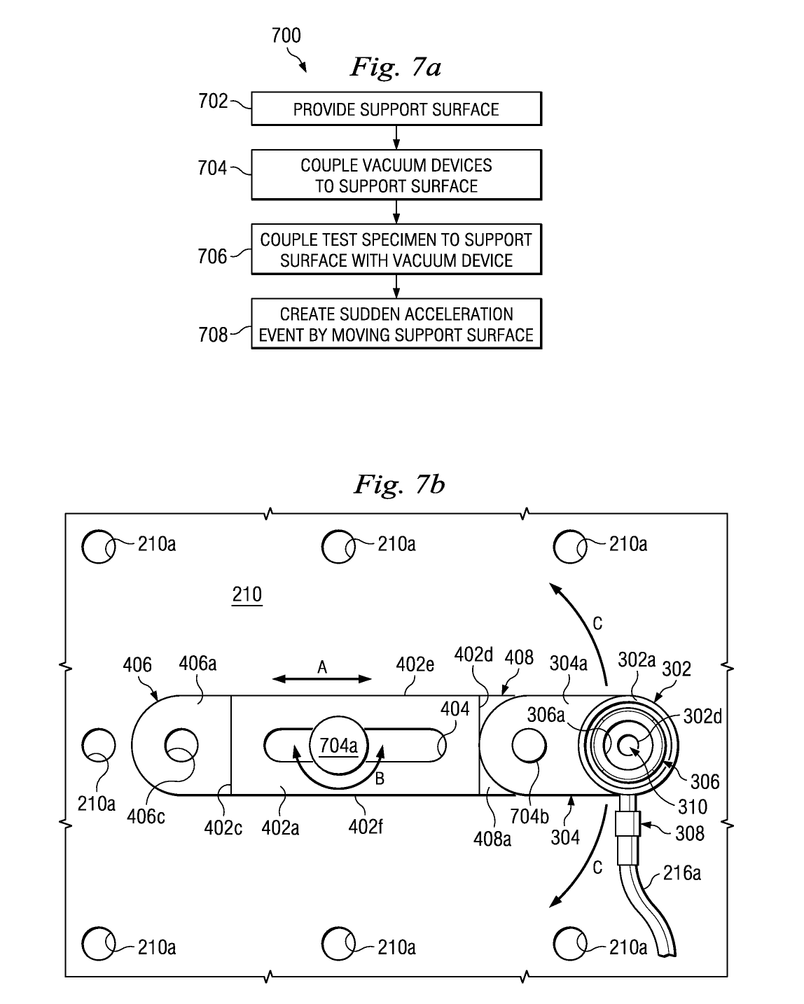

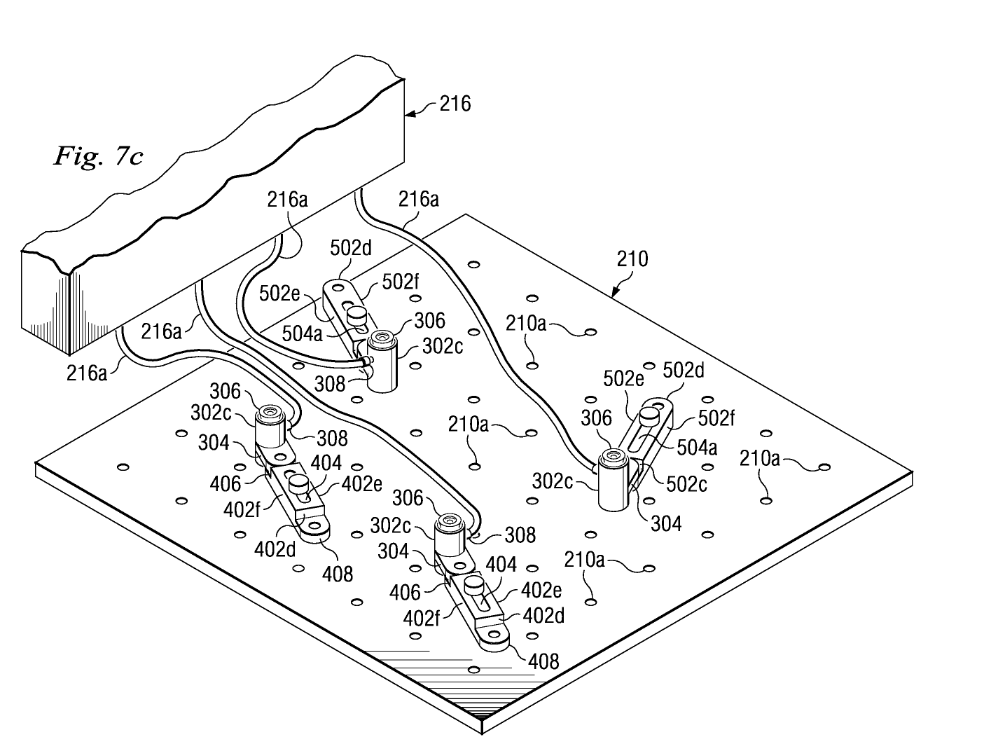

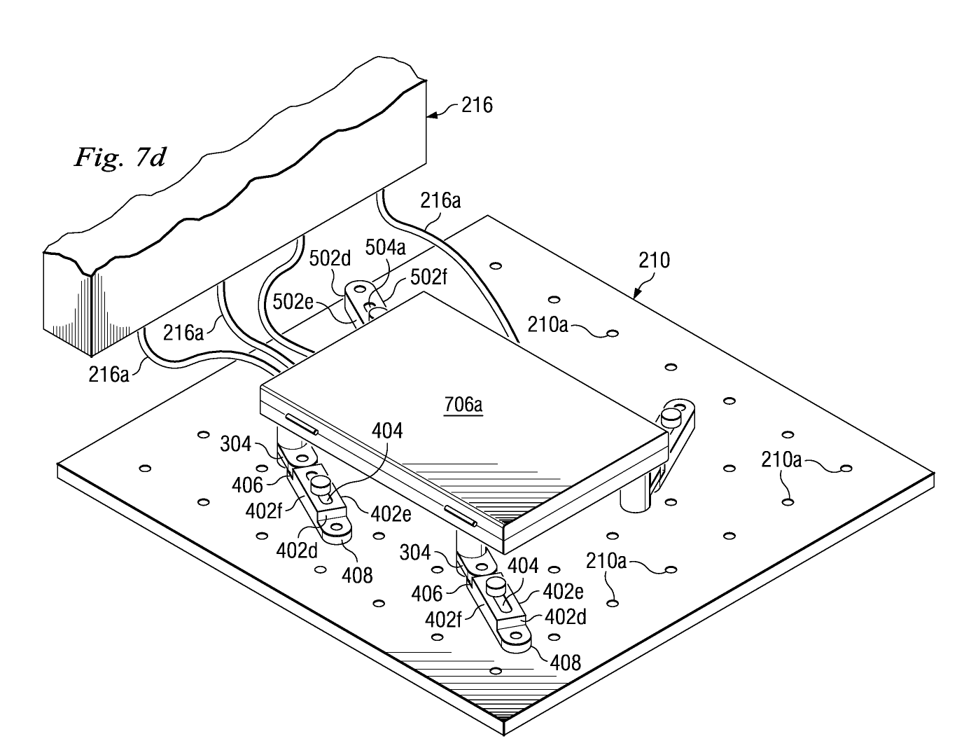

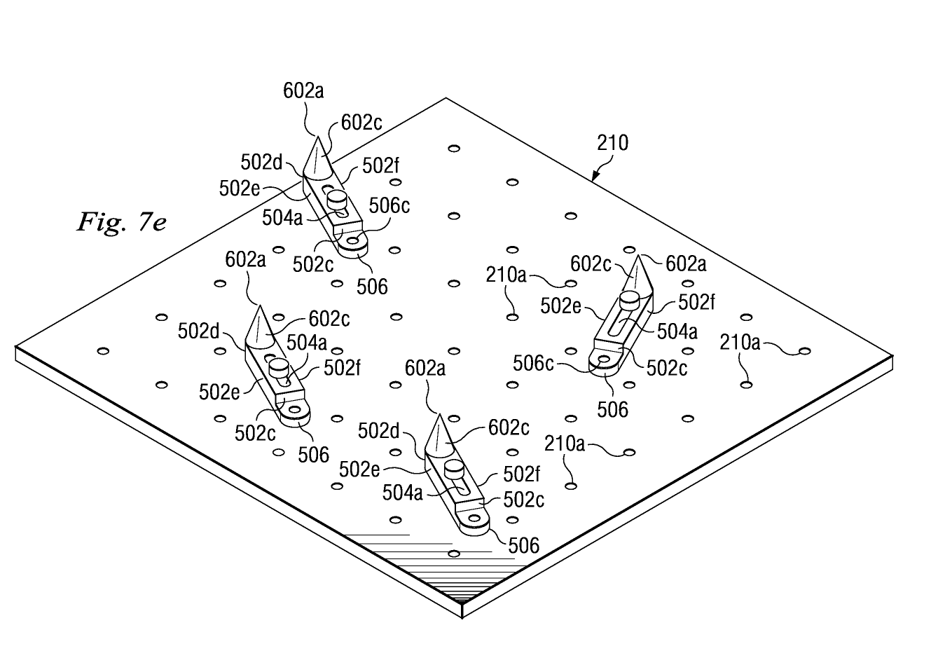

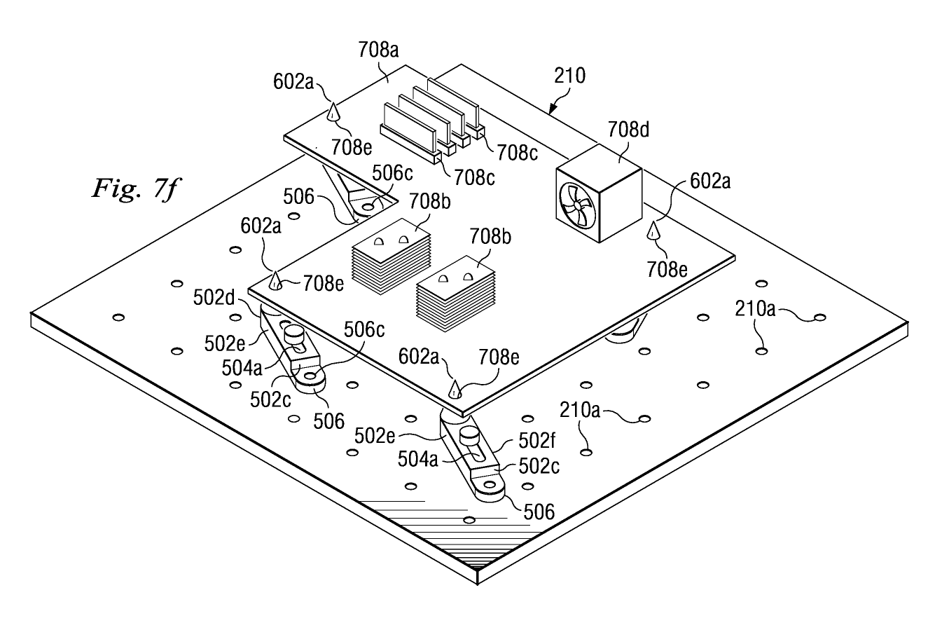

Referring now to FIGS. 2, 3, 4, 5, 7a, 7b and 7c, a method 700 for sudden acceleration testing a test specimen is illustrated. The method 700 begins at step 702 where the support surface 210, illustrated in FIG. 2, is provided. The method 700 then proceeds to step 704 where a plurality of vacuum devices 300, illustrated in FIG. 3, are coupled to the support surface 210. A fastener 704a may be positioned in the elongated support surface coupling passageway 404 defined by the vacuum device coupling member 400 such that it engages one of the aperture mounting features 210a on the support surface 210. In an embodiment, the aperture mounting feature 210a is a threaded hole, and the fastener 704a is a threaded fastener. With the fastener 704a engaging the aperture mounting feature 210a, the vacuum device coupling member 400 may move in a linear direction A relative to the fastener 704a and the vacuum device coupling member 400 may rotate in a direction B about the fastener 704a, as illustrated in FIG. 7b. The movement of the vacuum device coupling member 400 may be limited by tightening the fastener 704a to the aperture mounting feature 210a. The vacuum device coupling member 500 may be coupled to the support surface 210 in substantially the same manner as described above. A fastener 704b is then positioned in the aperture 304c defined by the coupling arm 304 on the vacuum device 300 and in the vacuum device coupling aperture 408c defined by the coupling arm 408 on the vacuum device coupling member 400. In an embodiment, the vacuum device coupling aperture 408c is a threaded hole, and the fastener 704b is a threaded fastener. With the fastener 704b engaging the vacuum device coupling aperture 408c, the vacuum device 300 may rotate in a direction C about the fastener 704b, as illustrated in FIG. 7b. The movement of the vacuum device 300 may be limited by tightening the fastener 704b to the vacuum device coupling aperture 408c. The vacuum device 300 may be coupled to the coupling arm 506 of the vacuum device coupling member 500 in substantially the same manner as described above. A plurality of the vacuum devices 300 may be coupled to the support surface 210 as described above and moved about their couplings in order to place the vacuum device 300 in a desired location, as illustrated in FIG. 7c. The hoses 216a are then coupled to respective hose couplings 308 on the vacuum devices 300. While the vacuum devices 300 have been illustrated as being coupled to the support surface 210 with the vacuum device coupling members 400 and 500, in an embodiment, the vacuum devices 300 may be an integral part of the support surface 210 or may be coupled directly to the support surface 210 without the vacuum device coupling members 400 and 500.

Referring now to FIGS. 2, 3, 7a, 7c, and 7d, the method 700 proceeds to step 706 where a test specimen is coupled to the support surface 210 with the vacuum devices 300. A test specimen 706a which may be, for example, an IHS, an IHS component, or a variety of other test specimen known in the art, is positioned adjacent the vacuum devices 300 such that a surface of the test specimen 706a is located adjacent the surface engagement members 306 on the vacuum devices 300. The pump 216 is then activated, which pulls air from adjacent the surface engagement members 306, through the air entrance 302d is defined by the base 302, through the air passageway 310 defined by the base 302, through the air exit 308a defined by the hose couplings 308, and through the hoses 216a. The test specimen 706a is then engaged with the surface engagement members 306 on the vacuum devices 300, creating a vacuum between the test specimen 706a and the surface engagement members 306 that couples the test specimen 706a to the vacuum device 300 and the support surface 210, as illustrated in FIG. 7d. The method 700 then proceeds to step 708 where a sudden acceleration event is created by moving the support surface 210 relative to the base 202. The support surface 210 is operable to move in all six degrees of freedom using methods known in the art in order to create a shock and/or vibration event in the test specimen 706a. In an embodiment, the sudden acceleration testing apparatus 200 may also create a sudden temperature change or temperature cycling in the testing chamber 204 for further testing of the test specimen 706a. Thus, a method and apparatus are provided which allow a test specimen to be coupled to a support surface for sudden acceleration testing without using a compressive force that may damage the test specimen and introduce unwanted elements into the testing while allowing a larger variety of test specimens to be coupled to the support surface quickly and easily relative to conventional methods.

Referring now to FIGS. 5, 6, 7c, 7e and 7f, in an alternative embodiment, the vacuum devices 300 are removed from the vacuum device coupling members 500 and the vacuum device coupling member 400 are replaced with vacuum device coupling member 500. The board support devices 600, illustrated in FIG. 6, are then coupled to the vacuum device coupling member 500 by engaging the coupling member 604 on each board support device 600 with the board support device coupling aperture 504b on each vacuum device coupling member 500, as illustrated in FIG. 7e. In an embodiment, the board support device coupling aperture 504b is a threaded hole, and the coupling member 604 is a threaded fastener. A board test specimen 708a including a variety of IHS components 708b, 708c and 708d and defining a plurality of mounting apertures 708e, is coupled to the support surface 210 by positioning the board support devices 600 in the mounting apertures 708e on the board test specimen 708a such that the top surface 602a of each board support device 600 extends through the board test specimen 708a, as illustrated in FIG. 7f. The support surface 210 is operable to move in all six degrees of freedom using methods known in the art in order to create a shock and/or vibration event in the board test specimen 708a. In an embodiment, the sudden acceleration testing apparatus 200 may also create a sudden temperature change or temperature cycling in the testing chamber 204 for further testing of the board test specimen 708a.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A sudden acceleration testing apparatus, comprising:
a base;
a support surface moveably coupled to the base, wherein the support surface is operable to move relative to the base in order to create a sudden acceleration event; and
a vacuum device located on the support surface and operable to couple a sudden acceleration test specimen to the support surface.

2. The apparatus of claim 1, wherein the support surface includes a plurality of mounting features, whereby the vacuum device is coupled to the support surface by at least one of the plurality of mounting features.

3. The apparatus of claim 1, wherein the vacuum device is moveable relative to the support surface.

4. The apparatus of claim 1, further comprising:
a vacuum device coupling member moveably mounted to the support surface, wherein the vacuum device is mounted to the vacuum device coupling member.

5. The apparatus of claim 4, wherein the vacuum device coupling member is mounted to the support surface by a fastener, whereby the vacuum device coupling member is operable to move linearly relative to the fastener and rotatably about the fastener.

6. The apparatus of claim 4, wherein the vacuum device is pivotally mounted to the vacuum device coupling member.

7. The apparatus of claim 1, further comprising:
a pump; and
a hose extending from the pump and coupled to the vacuum device.

8. The apparatus of claim 1, further comprising:
an information handling system sudden acceleration test specimen coupled to the support surface by a vacuum that is provided by the vacuum device.

9. A sudden acceleration testing apparatus, comprising:
a base defining a testing chamber;
a support surface located in the testing chamber and moveably coupled to the base, wherein the support surface is operable to move relative to the base in order to create a sudden acceleration event; and
a plurality of vacuum devices located on the support surface and operable to couple a sudden acceleration test specimen to the support surface.

10. The apparatus of claim 9, wherein the support surface includes a plurality of mounting features, whereby the plurality of vacuum devices are each coupled to the support surface by at least one of the plurality of mounting features.

11. The apparatus of claim 9, wherein the plurality of vacuum device are moveable relative to the support surface.

12. The apparatus of claim 9, further comprising:
a plurality of vacuum device coupling members moveably mounted to the support surface, wherein the plurality of vacuum devices are each mounted to a respective vacuum device coupling member.

13. The apparatus of claim 12, wherein each vacuum device coupling member is mounted to the support surface by a fastener, whereby each the vacuum device coupling member is operable to move linearly relative to the fastener and rotatably about the fastener.

14. The apparatus of claim 12, wherein each vacuum device is pivotally mounted to a respective vacuum device coupling member.

15. The apparatus of claim 9, further comprising:
a pump; and
a plurality of hoses each extending from the pump and coupled to a respective vacuum device.

16. The apparatus of claim 9, further comprising:
an information handling system sudden acceleration test specimen coupled to the support surface by a vacuum that is provided by the plurality of vacuum devices.

17. The apparatus of claim 9, wherein the base is operable to provide an gastight seal for the testing chamber.

18. The apparatus of claim 9, wherein the base includes a temperature regulation device that includes a nitrogen introduction system that allows the testing chamber to be filled with nitrogen in order to allow the testing chamber to be rapidly cooled.

19. A method for sudden acceleration testing a test specimen, comprising:
providing a support surface moveably coupled to a base and comprising a vacuum device located on the support surface;
coupling a sudden acceleration test specimen to the support surface by providing a vacuum between the sudden acceleration test specimen and the vacuum device; and
creating a sudden acceleration event in the sudden acceleration test specimen by moving the support surface relative to the base.

20. The method of claim 19, further comprising:
moving the vacuum device relative to the support surface.
